(19) United States
(12) Patent Application Publication
(10) Pub. No.: US 2024/0098154 A1
(43) Pub. Date: Mar. 21, 2024

(54) PROXIMITY-TRIGGERED DELIVERY OF PEOPLE HIGHLIGHTS

(71) Applicant: Microsoft Technology Licensing, LLC, Redmond, WA (US)

(72) Inventor: Aleksander Øhrn, Oslo (NO)

(21) Appl. No.: 17/946,680

(22) Filed: Sep. 16, 2022

(51) Int. Cl. H04L 67/52; H04L 67/55

(52) U.S. Cl. CPC H04L 67/52; H04L 67/55; G06Q 50/01

(57) ABSTRACT

A computer-implemented method of proximity-triggered delivery of people highlights can include receiving a plurality of highlight requests from a plurality of users; determining, from the plurality of highlight requests, that a first user of the plurality of users is physically proximate to a second user of the plurality of users; accessing information associated with the first user and accessing information associated with the second user; determining a relationship between the first user and the second user based on the information associated with the first user and the information associated with the second user; and obtaining a highlight based on the determined relationship between the first user and the second user.

### BACKGROUND

Surfacing information about people we know about can be a useful tool for improving and increasing online and offline interactions. For example, notifying users of their friends' or contacts' birthdays in a social media application can increase online interactions between the user and their friend or contact. As another example, providing highlighted information about colleagues in an enterprise (e.g., as part of a profile card or personal and/or work-related highlights included as part of a profile of that person) can assist finding the right individual for a task and/or humanize someone only seen online. For the user experience, these types of content can support specific jobs or assist in bringing warmth between people.

Currently, people may seek out this additional information about their friends or contacts, for example, by looking up a profile or clicking on notifications to view the notifications. This information (e.g., a user profile, notification, etc.) is useful in the context of improving online interactions. However, not only is the purpose of the information to improve online interactions, this type of information is generally accessed by an active step of the user and may require knowledge of a person's name or an account of the person of interest.

### BRIEF SUMMARY

Proximity-triggered delivery of people highlights is provided. The described delivery of people highlights can provide users with online information about those in their physical proximity to assist and encourage offline interactions. The described delivery of people highlights can be implemented through a highlight service that assists with facilitating communication and building interpersonal relationships between users in an “offline” (e.g., in person) setting by providing users, via their mobile devices, with conversation starters and/or highlights based on a relationship between them.

A computer-implemented method of proximity-triggered delivery of people highlights (e.g., for processing user highlight requests via a highlight service) can include receiving a plurality of highlight requests from a plurality of users; determining, from the plurality of highlight requests, that a first user of the plurality of users is physically proximate to a second user of the plurality of users; accessing information associated with the first user and accessing information associated with the second user; determining a relationship between the first user and the second user based on the information associated with the first user and the information associated with the second user; and obtaining a highlight based on the determined relationship between the first user and the second user.

The relationship between the first user and the second user can be determined based on social media or enterprise information where a highlight is then based on mutual contextual relevance and/or statistical analysis to identify a commonality between the first user and the second user that is statistically uncommon or uncommonly different with respect to other users.

In some cases, receiving the plurality of highlight requests from the plurality of users includes receiving a first highlight request from a first computing device associated with the first user, the first highlight request indicating proximity to a second computing device; and receiving a second highlight request from the second computing device associated with the second user, the second highlight request indicating proximity to the first computing device. In some cases, the first highlight request further includes an indication that the first computing device is proximate to a beacon, and wherein the second highlight request further includes an indication that the second computing device is proximate to the beacon.

In some cases, receiving the plurality of highlight requests from the plurality of users includes receiving the plurality of highlight request from a plurality of users via a beacon; and receiving a beacon highlight request from the beacon, the beacon highlight request indicating proximity to a first computing device and indicating proximity to a second computing device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an operating environment of a highlight service providing proximity-triggered delivery of people highlights.

FIG. 2 illustrates a computer-implemented method of proximity-triggered delivery of people highlights via a highlight service.

FIGS. 3A and 3B illustrate example scenarios of proximity-triggered delivery of people highlights.

FIG. 4 illustrates an example scenario of proximity-triggered delivery of people highlights incorporating a beacon.

FIG. 5 illustrates components of a computing device that may be used in certain implementations described herein.

FIG. 6 illustrates components of a computing system that may be used to implement certain methods and service described herein.

### DETAILED DESCRIPTION

Proximity-triggered delivery of people highlights is provided. The described delivery of people highlights can provide users with online information about those in their physical proximity to assist and encourage offline interactions. The described delivery of people highlights can be implemented through a highlight service that assists with facilitating communication and building interpersonal relationships between users in an “offline” (e.g., in person) setting by providing users, via their mobile devices, with conversation starters and/or highlights based on a relationship between them.

As described herein, a highlight is a contextually relevant notification pertaining to a relationship between two or more users. For example, a contextually relevant notification pertaining to a relationship between two users may be that they each listen to the same Dungeons and Dragons podcast. In some cases, the highlight may be contextual to the setting (e.g., each user has the same employer) in which the two users may interact. For example, two users who both arrive at a coffee shop and stand in line next to each other may be more interested in a highlight that is a personal interest (e.g., they each listen to the same Dungeons and Dragons podcast), while two users who are both in the same elevator at the same time at work may be more interested in a highlight that is work-related (e.g., they each worked on the same project at different stages of development yet had no direct interaction with each other on that project and would otherwise not know that highlight about their relationship).

The described highlight services encourage in-person, interpersonal interactions by providing users with a shared highlight. A goal of the highlight is to present a relevant or interesting topic, chosen in the hopes of facilitating conversation between users who are physically proximate to one another. The highlight service accesses information associated with the users and determines a relationship between them based on the accessed information. The highlight service may then obtain a highlight based on the determined relationship between the users. This highlight may then be sent/pushed to both user's devices, providing them each with a relevant fact or interesting conversation starter, in the hopes that the highlight will spark conversation between them.

Online services, such as social media services (e.g., Facebook, LinkedIn, etc.) and enterprise services (e.g., Microsoft365, Teams, etc.) have amassed databases full of user specific data and information. However, currently, this information is nearly impossible to access about someone who is not known. While it may be useful to know that a co-worker who is passed in the hall everyday loves the same Dungeons & Dragons podcast, in lieu of asking them directly for this fact, there is no way to know that there is this shared commonality with the co-worker just in passing them, for example, on the way to a water fountain.

When two users—who both have opted in to the service—are proximate to one another, embodiments of the described highlight service can determine that the users are physically proximate one another, access information associated with each user separately, determine a relationship between the users based on the accessed information, and obtain a highlight based on that relationship. For example, if a user passes a co-worker, who shares their passion for a certain Dungeons & Dragons Podcast (e.g., determined by the highlight service when identifying that both individuals are members of a group on social media regarding the podcast or both liking a page or an account about or by the podcast), the highlight service may obtain a highlight regarding this shared interest and send both the user and their co-worker a communication containing that highlight. Then, hopefully, knowing this shared interest outlined by the highlight will encourage an in-person introduction between the user and their co-worker.

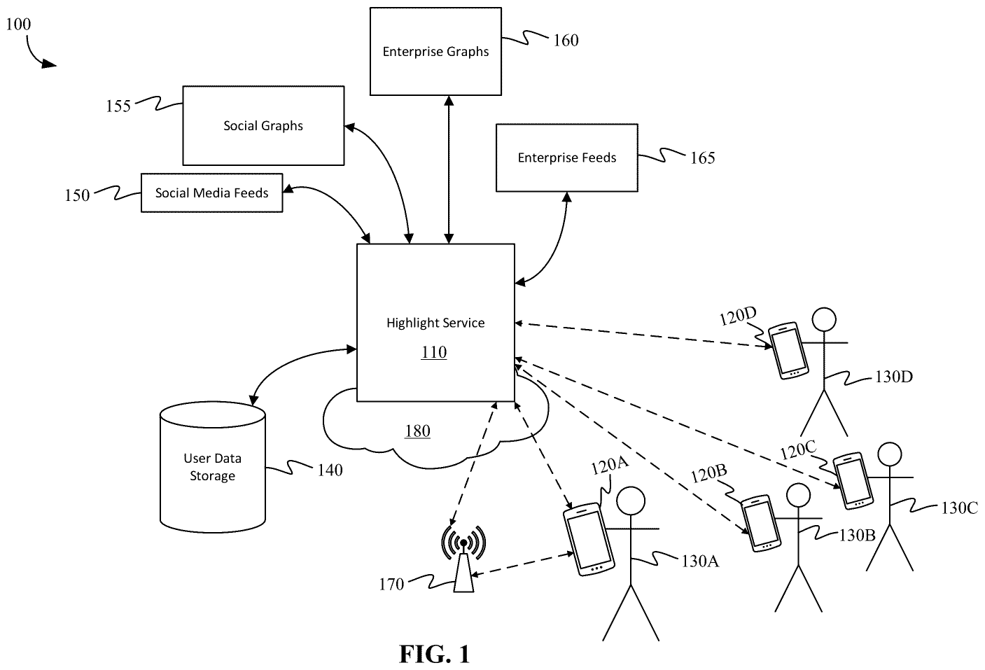

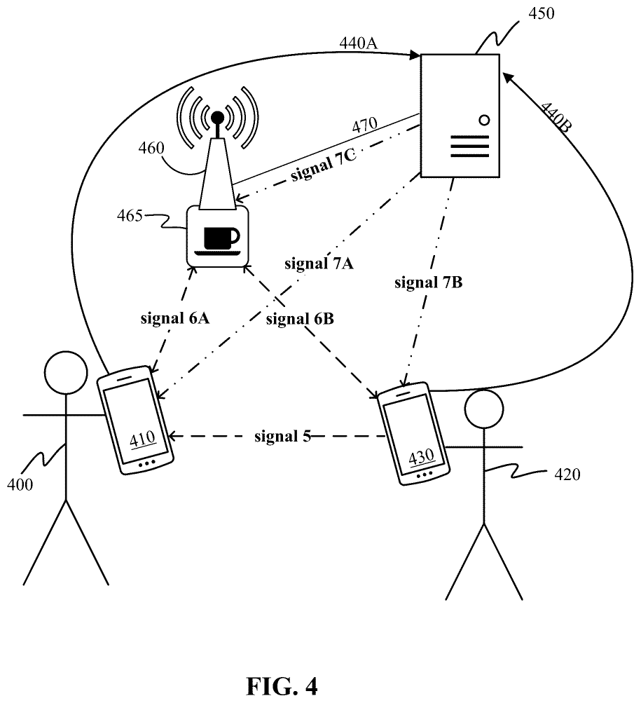

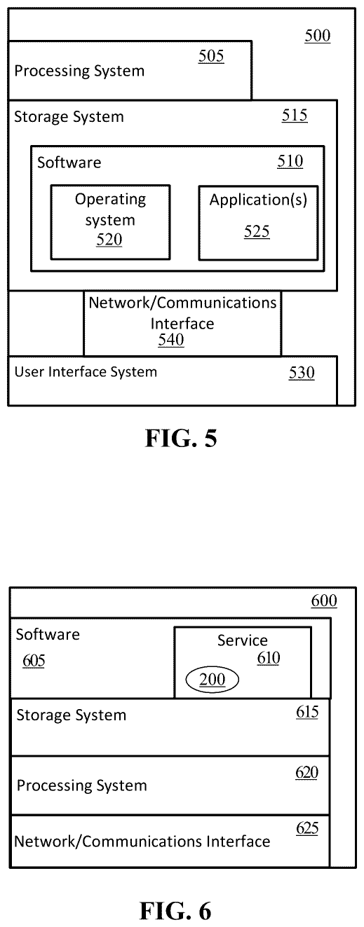

FIG. 1 illustrates an operating environment of a highlight service providing proximity-triggered delivery of people highlights. Referring to FIG. 1, an example operating environment 100 includes highlight service 110, which may be embodied as part of computing system 600 described with respect to FIG. 6, and a plurality of user computing devices (e.g., 120A, 120B, 120C, 120D), each which may be embodied as described with respect to system 500 of FIG. 5. Each user computing device (e.g., 120A, 120B, 120C, 120D) is associated with a corresponding one of various users (e.g., 130A, 130B, 130C, 130D). Operating environment 100 can also include user data storage 140, which may be implemented as part of the same computing system or different computing system as that implementing the highlight service 110, and social media feeds 150, social graphs 155, enterprise graphs 160, and enterprise feeds 165, which can be accessed by the highlight service 110 (e.g., by available application programming interfaces (APIs) or directly).

In some cases, operating environment 100 includes beacons (e.g., beacon 170) which provide location information of a user to the highlight service 110 directly or through the user's computing device (e.g., user computing device 120A). A beacon, in the context of location-based services, is a small hardware device that enables data transmission to mobile devices within a specific range of the device. A beacon is a wireless device that broadcasts its presence (e.g., transmits a unique identifier) over a radio transmitter (e.g., Wi-Fi, Bluetooth, etc.). A radio-equipped device (e.g., phone, gateway, access point) can detect a beacon when the device is in range. Beacon 170 can be implemented using any suitable computing device.

Systems, components, and devices illustrated in operating environment 100 can communicate with the highlight service 110 over network 180 Network 180 can include, but is not limited to, a cellular network, a satellite network, the Internet, a local area network (LAN), a wide area network (WAN), a WiFi network, an ad hoc network, or a combination thereof. The network 180 may include one or more connected networks (e.g., a multi-network environment) including public networks, such as the Internet, and/or private networks such as a secure enterprise private network. Access to the network 180 may be provided via wired and/or wireless means as will be understood by those skilled in the art. As will also be appreciated by those skilled in the art, communication networks can take several different forms and can use several different communication protocols.

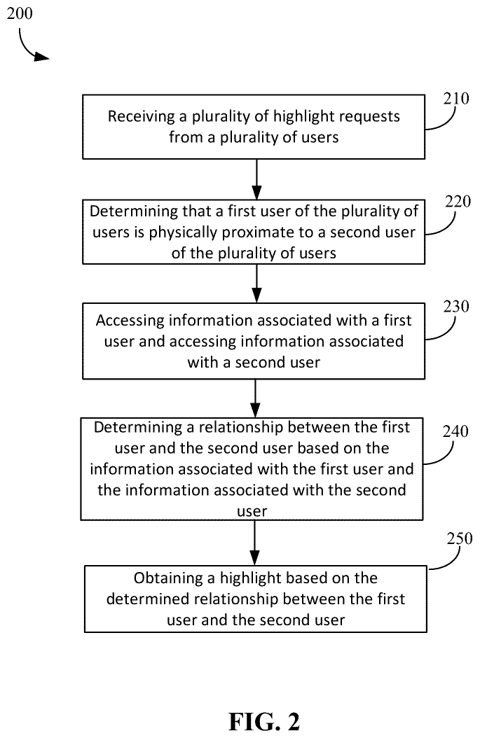

The highlight service 110 can perform operations such as described with respect to method 200 of FIG. 2. The highlight service 110 receives highlight requests from computing devices, such as user computing devices 120A, 120B, 120C, 120D, and/or beacons, such as beacon 170. A highlight request refers to a request for the content/highlight associated with a proximate user. As depicted in FIG. 1, highlight service 110 communicates with a multitude of computing devices (and may do so simultaneously).

In some cases, the highlight service 110 may access user data from the user data storage 140 when identifying users corresponding to computing devices that send highlight requests. User data stored in user data storage 140 may include, but is not limited to, user's names, addresses, account information, corporation affiliation, etc. In some cases, the user data storage 140 is part of the system (e.g., one or more servers) executing the highlight service 110. In some cases, the user data storage 140 is a separate system accessed by the highlight service 110.

To obtain the highlight for responding to the highlight requests, the highlight service 110 may rely on various sources that contain information associated with users. For example, the highlight service 110 can obtain/access information about users by accessing social media feeds 150, social graphs 155, enterprise graphs 160, and/or enterprise feeds 165 to search for information about the users. This list of sources containing user information is not exhaustive, and the highlight service may access information from any source potentially storing information associated with a user.

FIG. 2 illustrates a computer-implemented method of proximity-triggered delivery of people highlights via a highlight service. Referring to FIG. 2, a computer-implemented method 200 of proximity-triggered delivery of people highlights via a highlight service can include receiving (210) a plurality of highlight requests from a plurality of users, determining (220) that a first user of the plurality of users is physically proximate to a second user of the plurality of users, accessing (230) information associated with the first user and accessing information associated with a second user, determining (240) a relationship between the first user and the second user based on the information associated with the first user and the information associated with the second user, and obtaining (250) a highlight based on the determined relationship between the first user and the second user.

Receiving (210) the plurality of highlight requests from a plurality of users can include receiving a first highlight request from a first computing device associated a first user from a first computing device associated with the first user (e.g., computing device 120A associated with user 130A of FIG. 1) and receiving a second highlight request from the second computing device associated with the second user (e.g., computing device 120B associated with user 130B of FIG. 1). The first highlight request can indicate proximity of the first computing device to a second computing device and the second highlight request can indicate proximity of the second computing device to the first computing device. In some cases, the first highlight request sent from the first computing device includes user identification information corresponding to the second user and the second highlight request sent from the second computing device includes user identification information corresponding to the first user. In some cases, the first highlight request sent from the first computing device includes device identification information corresponding to the first computing device and the second highlight request sent from the second computing device includes device identification information corresponding to the second computing device.

In some cases, a highlight request from one computing device (e.g., the first computing device) indicates more than one computing devices are proximate. The multiple device indication may be provided in a single highlight request message or in multiple messages from the computing device to the highlight service. In some cases, a highlight request from a computing device may indicate proximity to a beacon (e.g., beacon 170 of FIG. 1) in addition to the one or more proximate computing devices.

In some cases, receiving (210) the plurality of highlight requests can include receiving a highlight request via a beacon, which can be referred to as a beacon highlight request. In some cases, the plurality of highlight requests includes highlight requests from user computing devices and at least one beacon highlight request. A beacon highlight request indicates proximity of a particular beacon to a first computing device corresponding to the first user and a second computing device corresponding to a second user (and optionally additional computing devices corresponding to additional users that may all be proximate the beacon). In some cases, the beacon highlight request is sent by the beacon after the beacon communicates with at least two proximate computing devices.

Determining (220) that a first user of the plurality of users is physically proximate to a second user of the plurality of users can include determining from the first highlight request and the second highlight request that the first computing device is proximate to the second computing device.

When device identification information is provided as part of the highlight request, the highlight service may rely on user data accessed from, for example, user data storage 140 of FIG. 1, to identify a user corresponding to the computing device. The highlight service can identify, from a structured data resource having associations between device identification information (e.g., computing device identifiers) and/or user identification information (e.g., user identifiers), associations between corresponding computing device identifiers and/or user identifiers of the first computing device and the second computing device. The corresponding user identifiers indicate the first user and the second user. In other words, the highlight service matches the device identifier, provided by the computing device, with information in a structured data resource to determine that the device identified in the request corresponds to a particular user.

While certain implementations can involve global position system (GPS) coordinates or other location information being sent with a highlight request, determining (220), from the plurality of highlight requests, that the first user of the plurality of users is physically proximate to the second user of the plurality of users does not require analyzing location information/GPS coordinates of computing devices associated with the two or more users to determine their proximity. In other words, the highlight service only needs information indicating that the two users are in close proximity, which can be inferred by the two or more devices indicating that the other device(s) are proximate in the highlight request (e.g., because the devices use a short-wave radio communication to detect proximate devices and then send that information to the highlight service). As described below, when GPS location information is provided, the GPS location information can be used for context used when considering highlights.

Accessing (230) information associated with a first user and accessing information associated with a second user includes accessing user information sources (e.g., social media feeds 150, social graphs 155, enterprise graphs 160, and enterprise feeds 165 as described with respect to FIG. 1) for information associated with a first user and information associated with a second user.

Determining (240) a relationship between the first user and the second user based on the information associated with the first user and the information associated with the second user can include evaluating the accessed information associated with the first user and evaluating the accessed information associated with the second user for commonalities. The relationship may be any definable relationship between users. For example, the users may be co-workers, the users may both be customers of the same establishment, and/or the users may all be alumni of the same university. There may be more than one commonality between users.

In some cases, determining (240) a relationship between the first user and the second user can include determining a common relationship between a first user, a second user, and a third user, based on information associated with the first user, information associated with the second user, and information associated with a third user. In some cases, determining (240) a relationship between the first user and the second user based on the information associated with the first user and the information associated with the second user can include relying on information associated with a beacon.

Obtaining (250) a highlight based in part on the information associated with the relationship between the first user and the second user may include obtaining a single highlight. In some cases, obtaining (250) a highlight based in part on the information associated with the relationship between the first user and the second user includes obtaining a plurality of highlights. The highlights can be part of existing profiles of the users or created from accessed information about the users (and which are associated with the users). In some cases, obtaining (250) a highlight includes determining the contextual relevance of the plurality of highlights. There are several types of contexts that the highlight service may consider when determining the contextual relevance of the plurality of highlights. These contexts include application context, relational context, personal context, and temporal context.

Application context is any context provided by anything that is known by the computing device, that the computing device sends to the highlight service. Examples of application context include, but are not limited to, GPS location information, status of an application (e.g., whether the application is in use), and battery status.

Relational context is any context provided by the relationship between the users. The highlight service determines (240) a relationship. Context provided by this relationship may assist the highlight service in obtaining a highlight. Examples of relational context include, but are not limited to, the users being co-workers, the users have a mutual friend, how well the users know each other, and in what manner that the users know each other. As an illustration for where the relational context indicates the users are co-workers, the highlight service may obtain a highlight related to a common work-place topic or event. As an illustration for where the relational context indicates that the users have a mutual friend, the highlight service may obtain a highlight related to that mutual friend.

Personal context is context about a user individually. Examples of personal context include, but are not limited to, a birthdate, a place of birth, a religion, a hobby, a preference, etc. of the individual user. In some cases, the users may be strangers, but both frequently volunteer at the same animal rescue shelter; given this mutual, personal context, the highlight service may obtain a highlight related to animals, or specific events at that animal rescue shelter.

Temporal context is context that is time dependent. For example, temporal context may be the current time of day, whether it is morning or evening, and/or what a user's upcoming calendar/schedule looks like. As an illustrative example, both users may have a karate class scheduled on their calendars; with this temporal context, the highlight service may obtain a highlight related to karate. As another illustrative example, the temporal context may be that it is morning time; with this temporal context, the highlight service may obtain a highlight pertaining to breakfast and/or coffee preferences (as opposed to a highlight pertaining to alcoholic beverage preference, which may be obtained with temporal context of the evening).

In some cases, obtaining (250) a highlight based in part on the information associated with the relationship between the first user and the second user includes ranking a plurality of highlights based on contextual relevance. The contextual relevance can include one or more of application context, relational context, personal context, and temporal context. For example, if the relationship between the users is that the users are co-workers, a highlight pertaining to a new office feature may rank above a highlight that both users frequent the same night club, because of the relational contextual relevance (e.g., that the users are co-workers), the highlight service may prioritize work-appropriate subjects over personal ones.

In some cases, obtaining (250) a highlight based in part on the information associated with the relationship between the first user and the second user includes performing statistical analysis on the accessed information associated with the first user and the accessed information associated with the second user. In some cases, obtaining (250) a highlight includes obtaining the highlight that is the most statistically uncommon (or uncommonly different), as explained in detail below.

Performing statistical analysis on the accessed information may include determining a highlight with statistical significance in comparison to a reference population. For example, if two co-workers work in the United States, where the standard language is English, the reference population may be English speakers. If the highlight service performs statistical analysis on the accessed information associated with the first and second user, and determines that both users speak Finnish, this would likely be a statistical rarity among the reference population of English speakers. However, if the co-workers worked in Finland, the fact that both users speak Finnish would have less statistical significance, and the highlight service may not obtain a highlight pertaining to that fact.

While operations 220, 230, 240, and 250 are described with respect to two users, the described operations are applicable to obtaining a highlight based on a determined relationship between a plurality of users (e.g., who are determined to be in proximity to each other). For example, a highlight can be obtained based in part on information associated with a common relationship between a first user, a second user, and a third user. As an illustrative example, if the first user and the third user both speak Armenian, but the second user does not, the obtained highlight would not involve the ability to speak Armenian, because that does not relate to a common relationship between all three users. However, if the first user, the second user, and the third user all participate in recreational paddle boarding, the highlight may be based on this commonality.

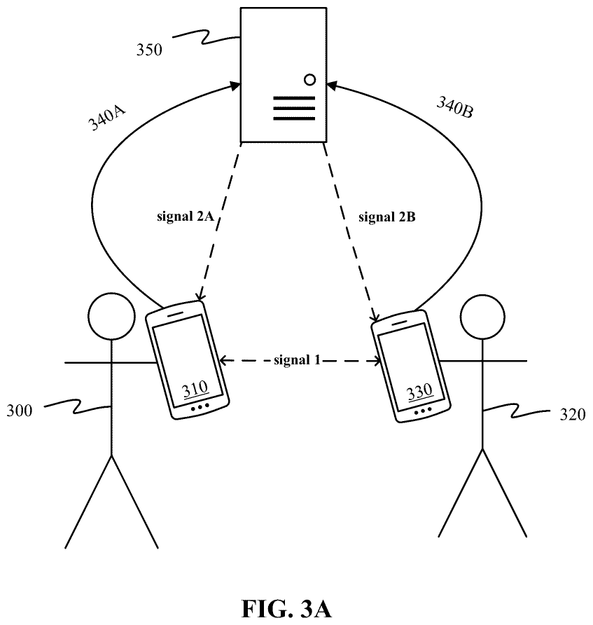

FIGS. 3A and 3B illustrate example scenarios of proximity-triggered delivery of people highlights. Referring to FIG. 3A, in a first example scenario, a first user 300 with a first computing device 310 and a second user 320 with a second computing device 330 are in physical proximity to each other. The first computing device 310 and the second computing device 330 may be implemented such as described with respect to system 500 of FIG. 5. For example, the first computing device 310 and the second computing device 320 may be mobile devices, such as a mobile phone or a laptop computer. Computing devices 310 and 330 may be running an application that knows how to communicate with the highlight service 350 (e.g., is associated with or includes a feature—built-in or a plug-in—that communicates with the highlight service 350 for example via an appropriate API).

As an example, assume that the first user 300 and the second user 320 are co-workers yet work in different departments in a large office building with hundreds of other employees. The users 300, 320 have never met, though they frequently see each other while working in the same office building. If both users 300, 320 entered the elevator together, their proximity to each other triggers the connection/communication illustrated by signal 1 to exchange device identifiers and/or user identifiers (depending on the application running at the device). In some cases, this connection/communication is established via a Bluetooth or other short-wave communication connection established between the first computing device 310 and the second computing device 330. The proximity detection may be an active feature of the operating systems of the devices 310 and 330 or of the application associated with the highlight service 350.

After the communication of signal 1 occurs between devices 310, 330, the first computing device 310 sends a first highlight request 340A to highlight service 350 and the second computing device 330 sends a second highlight request 340B to highlight service 350. The first highlight request 340A indicates that the first computing device 310 is proximate to the second computing device 330 and the second highlight request 340B indicates that the second computing device 330 is proximate to the first computing device 310. The first highlight request 340A includes the device identifier (e.g., of the second computing device 330) and/or the user identifier received during the communication associated with signal 1. The second highlight request 340B includes the device identifier (e.g., of the first computing device 310) and/or the user identifier received during the communication associated with signal 1 It should be noted that although the first highlight request 340A uses the term “first,” there is no requirement that this request be sent first in time, or prior to, the second highlight request 340B. The highlight request may be received in any order so long as the highlight requests are received within a period of time (e.g., contemporaneously).

Highlight service 350 receives the highlight requests 340A and 340B (along with any other highlight requests from any device that includes an application that can communicate with the highlight service 350) and performs operations such as described with respect to method 200 of FIG. 2. For example, after receiving highlight requests 340A and 340B, the highlight service 350 determines (220) that the first computing device 310 is proximate to the second computing device 330 (and vice versa) (and that the users associated with the computing devices are proximate to one another directly from receipt of user identifiers in the highlight requests or by looking up the user identifiers associated with received device identifiers, as examples).

The highlight service 350 can receive many highlight requests contemporaneously (e.g., from a plurality of computing devices such as computing devices 120A, 120B, 120C, and 120D of FIG. 1). The highlight service 350 is able to determine that two or more users are proximate to each other based on the mutuality of the request (e.g., User A's request identifies User B/second computing device and User B's request identifies User A/first computing device). This mutuality indicates proximity where, although the highlight service 350 is receiving potentially hundreds of highlight request simultaneously, the requests of individuals that are not proximate one another will not identify one another. In other words, the computing devices cannot communicate with one another (e.g., signal 1) if they are not within the required radius to establish proximity. If they cannot communicate, the subsequent highlight requests will not reference one another.

For example, in FIG. 3A, the highlight service 350 may receive an additional highlight request from an additional computing device at the same time as it receives both highlight request 340A and 340B from first computing device 310 and second computing device 330. However, if the additional highlight request does not indicate proximity to either the first computing device 310 or the second computing device 330, the highlight service 350 will not determine that the additional computing device is proximate either the first or second computing devices.

The highlight service 350 relies on the mutual recognition of first computing device 310 and second computing device 330 and the resulting, mutual highlight requests 340A and 340B when determining that these two computing devices (out of the plurality of devices that highlight service 350 receives requests from) are in proximity to one another.

In some cases, highlight requests, such as highlight requests 340A and 340B, may include a timestamp. The highlight service 350 may consider the temporal proximity of the timestamps when determining proximity of two or more users. However, it should be noted that the highlight service 350 may determine the proximity of the first computing device 310 and the second computing device 330 without the signals being simultaneously sent.

After determining that the first user 300 is physically proximate the second user 320, the highlight service 350 accesses information associated with the first user 300 and accesses information associated with the second user 320. The highlight service may access information from one or more information sources including social media and/or enterprise sources.

After accessing information associated with the first user 300 and the second user 320, the highlight service 350 determines a common relationship between the first user 300 and the second user 320 based on the accessed information associated with each user. As an illustrative example, the highlight service 350 may determine from the accessed information that the first user 300 and the second user 320 are co-workers. In this example, this information may have been gleaned from an enterprise feed or enterprise graph. In some cases, the enterprise-related information of both users belonging to the same enterprise and therefore being co-workers is part of the user data (e.g., user data stored in user data storage 140 of FIG. 1), which is then used to search the enterprise graph and/or access the enterprise feed.

The highlight service 350 obtains a highlight based on the determined relationship between the first user and the second user. Continuing with the example above, given the determination that the first user 300 and the second user 320 are co-workers, information from the enterprise graph and/or enterprise feed may be searched for commonalities (and the commonalities analyzed to obtain a highlight). In some cases, the obtained highlight is that the first user recently had a big sale at work. In some cases, the obtained highlight is that the first user and the second user are the only two who work at the company who speak Armenian, as examples. It may be the case that because these individuals are co-workers, the highlight service 350 discounts potential highlights as inappropriate for the workplace (e.g., both users may frequent the same night club, but the highlight service 350 may take the working relationship into account when choosing the highlight).

The highlight service 350 may then send the obtained highlight to both the first computing device 310 and the second computing device 330. Signal 2A illustrates the obtained highlight being sent to the first computing device 310 corresponding to the first user 300. Signal 2B illustrates the obtained highlight being sent to the second computing device 330 corresponding to the second user 320. In the illustrative example, the highlight can be “First User and Second User both speak Armenian.” This highlight can be communicated to both devices, hopefully providing both users with a conversation starter while they are in the elevator together.

The hope is that individuals, such as the first user 300 and the second user 320, who may cross paths daily, but have never, or rarely interacted, may be prompted to speak to one another after receiving a highlight based in part on information associated with a relationship between them provided by a highlight service, such as highlight service 350.

Referring to FIG. 3B, in another example scenario, a first user 301 with a first computing device 311, a second user 321 with a second computing device 331, and a third user 361 with a third computing device 371 are in physical proximity to each other. The first computing device 311, the second computing device 330, and the third computing device 371 may be implemented such as described with respect to system 500 of FIG. 5. For example, the first computing device 311, the second computing device 330, and the third computing device 371 may be mobile devices, such as a mobile phone or a laptop computer. As with the devices described in the scenario of FIG. 3A, computing devices 311, 331, and 371 are running an application that knows how to communicate with the highlight service 350 (e.g., is associated with or includes a feature—built-in or a plug-in—that communicates with the highlight service 350 for example via an appropriate API).

As an example, assume that the first user 301, the second user 321 and the third user 361 are all strangers, who are each patrons at the same bar. In this illustrative example, all three users' computing devices 311, 331, and 371 are cell phones running an application connected to highlight service 350.

When the first user 301, and particularly the first computing device 311, is physically proximate the second user 321 (e.g., within a radius sufficient for the first computing device 310 and the second computing device 331 to detect and/or communicate with each other), a communication between the first computing device 311 and the second computing device 331 can occur to exchange device identifiers and/or user identifiers (depending on the application running at the device). This communication is illustrated by the dashed-line, signal 3A. The third user 361 is also proximate both the first user 301 and the second user 321. As a result, the third computing device 371 communicates with the first computing device 311, as illustrated by dashed-line, signal 3C, to exchange device identifiers and/or user identifiers (depending on the application running at the device) and communicates with the second computing device 331, as illustrated by dashed-line signal 3B to exchange device identifiers and/or user identifiers (depending on the application running at the device).

Once proximity to other devices is determined by the first computing device 311, the first computing device 311 sends a first highlight request 341A to highlight service 350. Here, the first highlight request 341A indicates that the first computing device 311 is proximate to the second computing device 331 and to the third computing device 371. This first highlight request 341A can include the device identifier and/or the user identifier received during the communications associated with signal 3A and signal 3C. In some cases, the first highlight request 341A may include two separate communications, the first indicating that the first computing device 311 is proximate to the second computing device 331, and the second indicating that the first computing device 311 is proximate to the third computing device 371.

The second computing device 321 sends a second highlight request 341B to highlight service 350. Here, the second highlight request 341B indicates that the second computing device 321 is proximate to the first computing device 311 and to the third computing device 371. This second highlight request 341B can include the device identifier and/or the user identifier received during the communications associated with signal 3A and signal 3B. In some cases, the second highlight request 341B may include two separate communications, the first indicating that the second computing device 331 is proximate to the first computing device 311, and the second indicating that the second computing device 331 is proximate to the third computing device 371.

The third computing device 371 sends a third highlight request 341C to highlight service 350. Here, the third highlight request 341C indicates that the third computing device 371 is proximate to the first computing device 311 and to the second computing device 331. This third highlight request 341C can include the device identifier and/or the user identifier received during the communications associated with signal 3B and signal 3C. In some cases, the third highlight request 341C may include two separate communications, the first indicating that the third computing device 371 is proximate to the first computing device 311, and the second indicating that the third computing device 371 is proximate to the second computing device 331.

It should be noted that although the first highlight request 341A uses the term “first,” there is no requirement that this request be sent first in time, or prior to, the second highlight request 341B or the third highlight request 341C. Similarly, although the second highlight request 341B uses the term “second,” there is no requirement that this request be sent second in time, or prior to the third highlight request 341C or after the first highlight request 341A; and although the third highlight request 341C uses the term “third,” there is no requirement that this request be sent third in time, or after the first highlight request 341A or the second highlight request 341B. The highlight requests may be received in any order (and may be received simultaneously).

Highlight service 350 receives the highlight requests 341A, 341B and 341C (along with any other highlight requests from any device that includes an application that can communicate with the highlight service 350) and performs operations such as described with respect to method 200 of FIG. 2. For example, after receiving highlight requests 341A, 341B and 341C, the highlight service 350 determines that the first computing device 311 is proximate to the second computing device 331 (and vice versa), that the first computing device 311 is proximate to the third computing device 371 (and vice versa), and that the second computing device 331 is proximate to the third computing device 371 (and vice versa). In this manner, the highlight service 350 determines that the first computing device 311, the second computing device 331, and the third computing device 371 are all proximate to one another (and that the users associated with the computing devices are proximate to one another directly from receipt of user identifiers in the highlight requests or by looking up the user identifiers associated with received device identifiers, as examples).

After determining that the first user 301 is physically proximate both the second user 321 and the third user 361 the highlight service 350 accesses information associated with the first user 301, accesses information associated with the second user 321, and accesses information associated with the third user 361. The highlight service 350 may access information from several user information sources, including social media feeds, social media graphs, enterprise feeds, and enterprise graphs. The highlight service 350 may communicate with and/or search various user information sources to access information pertaining to the first user 301, the second user 321, and the third user 361.

After accessing information associated with the first user 301, the second user 321, and the third user 361, the highlight service 350 determines a common relationship between the first user 301, the second user 321, and the third user 361 based on the accessed information associated with each user. As an illustrative example, the highlight service 350 accesses one or more social media feeds where the users have profiles (the profiles may be of a same social media or a different social media platform). Information about the users' likes, content, etc. can be obtained and analyzed for commonalities. For example, the highlight service 350 may determine from the accessed information that all three users are alumni of the same university.

The highlight service 350 obtains a highlight based on the determined common relationship between the first user 301, the second user 321, and the third user 361. The highlight obtained may simply be the fact that first user 301, the second user 321, and the third user 361 attended the same university, or the highlight may be news that their alma mater recently won a football game against a rival, as examples. The highlight service 350 may obtain a single highlight. In some cases, the highlight service 350 obtains multiple potential highlights.

After obtaining the highlight, the highlight service 350 sends the obtained highlight to the first computing device 311, the second computing device 331, and the third computing device 371. Signal 4A illustrates the obtained highlight being sent to the first computing device 311 corresponding to the first user 301. Signal 4B illustrates the obtained highlight being sent to the second computing device 331 corresponding to the second user 321. Signal 4C illustrates the obtained highlight being sent to the third computing device 371 corresponding to the third user 361.

The example scenario may result in each of the three users at the bar striking up a conversation about the “good ole′ days” after receiving a highlight based on their common relationship as alumni.

It should be understood that the example scenario of FIG. 3B is not meant to be limiting to only three users. In some cases, there can be a more than three users proximate to one another and connecting to the highlight service to obtain a common highlight.

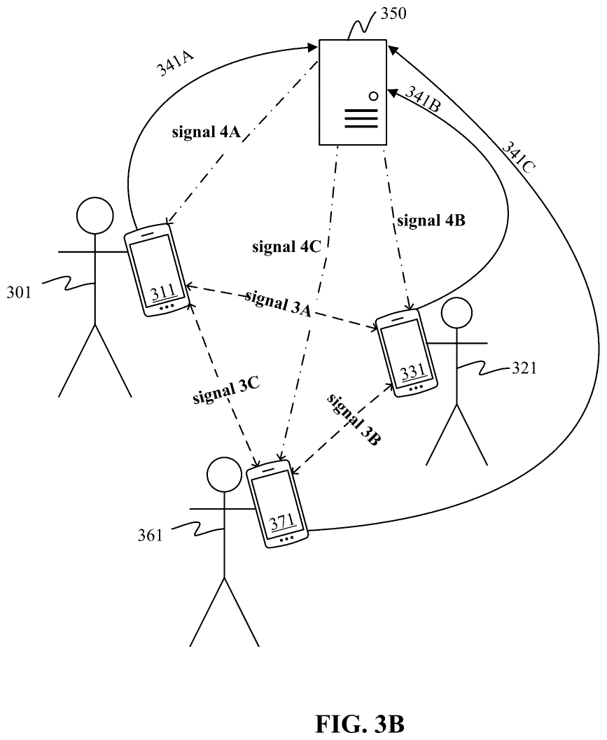

FIG. 4 illustrates an example scenario of proximity-triggered delivery of people highlights incorporating a beacon. As described above, beacons at known locations can communicate and exchange information with proximate computing devices. In some cases, the beacon may provide the computing device with location information. In other cases, the computing device may provide the beacon with device identification or user identification information.

Referring to FIG. 4, as an example, assume that the first user 400 and the second user 420 are strangers in the same coffee shop, located in coffee area 465. The coffee area 465 includes a beacon 460. Beacon 460 can be a small hardware device that enables data transmission to mobile devices within a specific range of the device and that broadcasts its presence (e.g., transmits a unique identifier) over a radio transmitter (e.g., Wi-Fi, Bluetooth, etc.).

In this example scenario, the first user 400 with first computing device 410 and the second user with second computing device 430 are within a distance that triggers communication between devices. That is, in the illustrative scenario, when the first user 400, and particularly the first computing device 410, is physically proximate the second user 420 (e.g., within a radius sufficient for the first computing device 410 and the second computing device 430 to detect and/or communicate with each other), a communication/connection between the first computing device 410 and the second computing device 430 can occur to exchange device identifiers and/or user identifiers. This communication/connection is depicted by the dashed-line, signal 5. In addition to determining proximate user computing devices, a user's computing device can capture location information from beacon 460.

In some cases, the beacon 460 may provide the first computing device 410 and the second computing device 430 with location information about the beacon's 460 location (e.g., the beacon is within the coffee shop in coffee area 465). In some cases, where the beacon 460 includes capabilities of communicating with highlight service 450 and receiving short-wave communications with proximate devices (e.g., the first computing device 410 and the second computing device 430), the beacon 460 may send a beacon highlight request, such as beacon highlight request 470 to the highlight service 450, containing indications that both the first computing device 410 and the second computing device 430 are nearby.

For example, when the first user 400, and particularly the first computing device 410, is proximate to beacon 460 at coffee area 465 (e.g., within a radius sufficient for beacon 460 and first computing device 410 to detect and/or communicate with each other) a communication between the first computing device 410 and the beacon 460 can occur, depicted by dashed line signal 6A. In scenarios where the beacon 460 broadcasts the location information, the first computing device 410 can receive the information without responding to the beacon 460. In scenarios where the beacon 460 captures information on nearby devices (upon opt-in by users), the beacon 460 can request and receive the device identifier of the first computing device 410 and/or the user identifier of the first user 400. Similarly, in some cases, when the second user 420, and particularly the second computing device 430, is proximate to beacon 460 at coffee area 465 (e.g., within a radius sufficient for beacon 460 and second computing device 430 to detect and/or communicate with each other) a communication/connection between the second computing device 430 and the beacon 460 can occur, depicted by dashed line signal 6B. In scenarios where the beacon 460 broadcasts the location information, the second computing device 430 can receive the information without responding to the beacon 460. In scenarios where the beacon 460 captures information on nearby devices (upon opt-in by users), the beacon 460 can request and receive the device identifier of the second computing device 430 and/or the user identifier of the second user 420.

Once the first computing device 410 determines proximity to another device (or devices including the beacon 460), the first computing device 410 sends a first highlight request 440A to highlight service 450. Once the second computing device 430 determines proximity to another device (or devices including the beacon 460), the second computing device 430 sends a second highlight request 440B to highlight service 450. Here, the first highlight request 440A indicates that the first computing device 410 is proximate the second computing device 430. The first highlight request 440A can further include the context information of the location broadcast by the beacon 460.

Similarly, the second highlight request 440B indicates that the second computing device 430 is proximate the first computing device 410. The second highlight request 440B can further include the context information of the location broadcast by the beacon 460.

It should be noted that the highlight requests 440A, 440B may be received by the highlight service 450 in any order and even simultaneously.

Highlight service 450 receives the highlight requests 440A and 440B (along with any other highlight requests from any device that includes an application that can communicate with the highlight service 450) and performs operations such as described with respect to method 200 of FIG. 2. For example, after receiving highlight requests 440A and 440B, the highlight service 450 determines that the first computing device 410 is proximate to the second computing device 430 (and vice versa), that the users associated with the computing devices are proximate to each other (directly from receipt of user identifiers in the highlight requests or by looking up the user identifiers associated with received device identifiers, as examples), and that each computing device is at a location associated with the beacon 460.

In some cases, the highlight service 450 can use information received with a beacon highlight request (e.g., beacon highlight request 470) to assist with determining that the first user 400 is physically proximate the second user 420 and to obtain context information regarding both users being at the location of the beacon 460. In some cases where the beacon 460 is able to communicate with the highlight service 450, the beacon highlight request 470 is sent in addition to, or in lieu of first highlight request 440A and second highlight request 440B.

For example, a beacon highlight request 470 that includes identifiers of the first computing device 410 and the second computing device 430 along with a location/beacon identifier can be received by the highlight service 450 and used by the highlight service 450 to identify that the first computing device 410 is proximate the second computing device 430 regardless of whether the highlight service 450 receives a first highlight request 440A or a second highlight request 440B.

After determining that first user 400 and second user 420 are physically proximate each other at a particular location (identified by the beacon 460), the highlight service 450 accesses information associated with the first user 400 and information associated with the second user 420. In some cases, information associated with the beacon location can be used for context of a search/access of information associated with the users and/or in a subsequent operation in selecting highlights. As previously described, the highlight service 450 may access information from one or more user information sources, including social media feeds, social media graphs, enterprise feeds, and enterprise graphs. The highlight service 450 may communicate with and/or search various user information sources to access information pertaining to the first user 400 and the second user 420.

After accessing information associated with the first user 400 and the second user 420, the highlight service 450 determines a relationship between the first user 400 and the second user 420, based on the accessed information associated with both users. In this example, the highlight service 450 may use the additional information provided by the beacon location to assist with obtaining a highlight. For example, the highlight service 450 may rely on the location information to determine that both users are in coffee area 465 and that one relationship between the users is that they are mutual coffee shop customers of the same coffee shop. In such a scenario, the highlight service 450 may access a social media feed and/or social graph and identify content related to coffee or beverages.

For example, the highlight obtained may be that both the first user 400 and the second user 420 frequently order iced americanos when patronizing the coffee shop in coffee area 465. In some cases, this information may be application context provided by data stored from past orders of an application accessible on user computing devices.

As another illustrative example, the highlight service 450 can access an enterprise graph due to the two users having user identifiers indicating that they are employees of a same company (but in different departments). The search of the enterprise graph shows that while the two users are not in the same department nor have they previously interacted, they both recently were issued registrations to a same event. This commonality (of the same event) may be obtained by the highlight service 450 as a highlight for the two users.

After obtaining the highlight, the highlight service 450 may then send the obtained highlight to the first computing device 410 and the second computing device 430, reflected by signal 7A and signal 7B. In some cases, the highlight service 450 may (when the beacon 460 is capable of communicating with highlight service 450) send/push a highlight to the beacon 460, reflected by signal 7C, which may be used to assist with providing a highlight to the first computing device 410 and/or the second computing device 430. It is also possible to use the beacon 460 to send a location specific highlight (e.g., related to the coffee area) to the devices (communication not shown). In some cases, the beacon 460 may locally store highlights obtained from the highlight service 450.

While FIG. 4 illustrates a scenario of two users proximate the beacon 460, any number of users may be proximate the beacon 460 and incorporate the location information as context to obtain a common highlight. For example, there may be a beacon, such as beacon 460, in a large conference room. As all of the users enter the conference room, their corresponding devices may communicate both with the beacon, and with one another. This may result in the highlight service, such as highlight service 450, obtaining a common highlight for each of the users in the conference room (and which may be related to the meeting in the conference room).

FIG. 5 illustrates components of a computing device that may be used in certain implementations described herein. Referring to FIG. 5, system 500 may represent a computing device such as, but not limited to, a personal computer, a tablet computer, a reader, a mobile device, a personal digital assistant, a wearable computer, a smartphone, a laptop computer (notebook or netbook), a gaming device or console, a desktop computer, or a smart television. Accordingly, more or fewer elements described with respect to system 500 may be incorporated to implement a particular computing device.

System 500, for example, includes a processing system 505 of one or more processors to transform or manipulate data according to the instructions of software 510 stored on a storage system 515. Examples of processors of the processing system 505 include general purpose central processing units, application specific processors, and logic devices, as well as any other type of processing device, combinations, or variations thereof.

The software 510 can include an operating system 520 and one or more application programs 525 that can communicate with a highlight service (e.g., highlight service 110 of FIG. 1). Examples of an application program 525 that can incorporate a feature to communicate with highlight service includes, but is not limited to an electronic messaging application, a collaboration application, a web browsing application, and/or a social media application. Collaboration applications can include, but are not limited to, team collaboration tools that support a variety of communications and content including, but not limited to, one or more of video, audio, text, file attachments, instant messages (e.g., exchanges between two—and sometimes more—people), chat messages (e.g., messaging within a chat room or other virtual meeting area), email, calendar entries, meeting entries, and the like. Examples of team collaboration tools include MICROSOFT TEAMS, SLACK, and FLOWDOCK. Other applications that include at least some meetings, collaboration, and messaging capabilities include FACEBOOK (and FACEBOOK MESSENGER), GOTOMEETING, and JOIN.ME. Collaboration applications can also include MICROSOFT365 and GOOGLE WORKSPACE. Example social media applications include FACEBOOK, INSTAGRAM, and TWITTER.

Device operating systems generally control and coordinate the functions of the various components in the computing device, providing an easier way for applications to connect with lower-level interfaces like the networking interface 540. In some cases, the operating system 520 may be able to communicate with the highlight service 110 to provide highlights directly to a user of the system 500 or via an application running on the system 500.

It should be noted that the operating system 520 may be implemented both natively on the computing device and on software virtualization layers running atop the native device operating system (OS). Virtualized OS layers, while not depicted in FIG. 5, can be thought of as additional, nested groupings within the operating system space, each containing an OS, application programs, and APIs.

Storage system 515 can include any computer readable storage media readable by the processing system 505 and capable of storing software 510 including application(s) 525. Storage system 515 may include volatile and nonvolatile, removable and non-removable media implemented in any method or technology for storage of information, such as computer readable instructions, data structures, program modules, or other data. Examples of storage media include random access memory, read only memory, magnetic disks, optical disks, CDs, DVDs, flash memory, virtual memory and non-virtual memory, magnetic cassettes, magnetic tape, magnetic disk storage or other magnetic storage devices, or any other suitable storage media. In no case is the storage medium of storage system a transitory propagated signal.

Storage system 515 may include additional elements, such as a controller, capable of communicating with processing system 505. The system can further include user interface system 530, which may include input/output (I/O) devices and components that enable communication between a user and the system 500. User interface system 530 can include input devices such as a mouse, track pad, keyboard, a touch device for receiving a touch gesture from a user, a motion input device for detecting non-touch gestures and other motions by a user, a microphone for detecting speech, and other types of input devices and their associated processing elements capable of receiving user input. The user interface system 530 may also include output devices such as display screens, speakers, haptic devices for tactile feedback, and other types of output devices. In certain cases, the input and output devices may be combined in a single device, such as a touchscreen display which both depicts images and receives touch gesture input from the user. Visual output may be depicted on the display in myriad ways, presenting graphical user interface elements, text, images, video, notifications, virtual buttons, virtual keyboards, or any other type of information capable of being depicted in visual form.

The user interface system 530 may also include user interface software and associated software (e.g., for graphics chips and input devices) executed by the OS in support of the various user input and output devices. The associated software assists the OS in communicating user interface hardware events to application programs using defined mechanisms. The user interface system 530 including user interface software may support a graphical user interface, a natural user interface, or any other type of user interface.

Communications/network interface 540 includes a short-wave communications interface supporting communications such as Bluetooth. Communications interface 540 may include communications connections and devices that allow for communication with other computing systems over one or more communication networks. Examples of connections and devices that together allow for inter-system communication may include network interface cards, antennas, power amplifiers, RF circuitry, transceivers, and other communication circuitry. Transmissions to and from the communications interface are controlled by the operating system 520, which informs applications of communications events when necessary.

It should be noted that certain elements of system 500 may be included in a system-on-a-chip (SoC) device. These elements may include, but are not limited to, the processing system 505, a communications interface 540, and even elements of the storage system 515.

FIG. 6 illustrates components of a computing system that may be used to implement certain methods and services described herein. Referring to FIG. 6, system 600 may be implemented within a single computing device or distributed across multiple computing devices or sub-systems that cooperate in executing program instructions. The system 600 can include one or more blade server devices, standalone server devices, personal computers, routers, hubs, switches, bridges, firewall devices, intrusion detection devices, mainframe computers, network-attached storage devices, and other types of computing devices. The system hardware can be configured according to any suitable computer architectures such as a Symmetric Multi-Processing (SMP) architecture or a Non-Uniform Memory Access (NUMA) architecture.

The system 600 can include a processing system 620, which may include one or more processors and/or other circuitry that retrieves and executes software 605 from storage system 615. Processing system 620 may be implemented within a single processing device but may also be distributed across multiple processing devices or sub-systems that cooperate in executing program instructions.

Examples of processing system 620 include general purpose central processing units, application specific processors, and logic devices, as well as any other type of processing device, combinations, or variations thereof. The one or more processing devices may include multiprocessors or multi-core processors and may operate according to one or more suitable instruction sets including, but not limited to, a Reduced Instruction Set Computing (RISC) instruction set, a Complex Instruction Set Computing (CISC) instruction set, or a combination thereof. In certain embodiments, one or more digital signal processors (DSPs) may be included as part of the computer hardware of the system in place of or in addition to a general purpose CPU.

As with storage system 515 (as shown in FIG. 5), storage system 615 can include any computer readable storage media readable by processing system 620 and capable of storing software 605. Storage system 615 may be implemented as a single storage device but may also be implemented across multiple storage devices or sub-systems co-located or distributed relative to each other. Storage system 615 may include additional elements, such as a controller, capable of communicating with processing system 620.

Software 605 may be implemented in program instructions and among other functions may, when executed by system 600 in general or processing system 620 in particular, direct the system 600 or processing system 620 to operate as described herein for providing highlight services (e.g., as service 610). For example, software 605 may provide program instructions that, for example, perform method 200 as described with respect to FIG. 2.

Software 605 may also include additional processes, programs, or components, such as operating system software or other application software. Software 605 may also include firmware or some other form of machine-readable processing instructions executable by processing system 620.

In embodiments where the system 600 includes multiple computing devices, the system can include one or more communications networks that facilitate communication among the computing devices. For example, the one or more communications networks can include a local or wide area network that facilitates communication among the computing devices. One or more direct communication links can be included between the computing devices. In addition, in some cases, the computing devices can be installed at geographically distributed locations. In other cases, the multiple computing devices can be installed at a single geographic location, such as a server farm or an office.

A communication interface 625 may be included, providing communication connections and devices that allow for communication between system 600 and other computing systems (e.g., including user computing devices 120A, 120B, 120C, 120D, social media feeds 150, social graphs 155, enterprise graphs 160, enterprise feeds 165, and beacons 170 as described with respect to FIG. 1) over a communication network or collection of networks (not shown) or the air.

Communication to and from client computing devices, beacons, and other computing systems (not shown) and the highlight service 610 may be carried out, in some cases, via application programming interfaces (APIs). An API is an interface implemented by a program code component or hardware component (hereinafter “API-implementing component”) that allows a different program code component or hardware component (hereinafter “API-calling component”) to access and use one or more functions, methods, procedures, data structures, classes, and/or other services provided by the API-implementing component. An API can define one or more parameters that are passed between the API-calling component and the API-implementing component. The API is generally a set of programming instructions and standards for enabling two or more applications to communicate with each other and is commonly implemented over the Internet as a set of Hypertext Transfer Protocol (HTTP) request messages and a specified format or structure for response messages according to a REST (Representational state transfer) or SOAP (Simple Object Access Protocol) architecture.

It should be understood that the examples and embodiments described herein are for illustrative purposes only and that various modifications or changes in light thereof will be suggested to persons skilled in the art and are to be included within the spirit and purview of this application.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts that would be recognized by one skilled in the art are intended to be within the scope of the claims.

What is claimed is:

1. A computer-implemented method of proximity-triggered delivery of people highlights comprising:
receiving a plurality of highlight requests from a plurality of users;
determining, from the plurality of highlight requests, that a first user of the plurality of users is physically proximate to a second user of the plurality of users;
accessing information associated with the first user and accessing information associated with the second user;
determining a relationship between the first user and the second user based on the information associated with the first user and the information associated with the second user; and
obtaining a highlight based on the determined relationship between the first user and the second user.

2. The method of claim 1, wherein receiving the plurality of highlight requests from the plurality of users comprises:
receiving a first highlight request from a first computing device associated with the first user, the first highlight request indicating proximity to a second computing device; and
receiving a second highlight request from the second computing device associated with the second user, the second highlight request indicating proximity to the first computing device.

3. The method of claim 2, wherein determining, from the plurality of highlight requests, that the first user of the plurality of users is physically proximate to the second user of the plurality of users comprises:
determining from the first highlight request and the second highlight request that the first computing device is proximate to the second computing device; and
identifying, from a structured data resource having associations between computing device identifiers and user identifiers, corresponding user identifiers of the first computing device and the second computing device, the corresponding user identifiers indicating the first user and the second user.

4. The method of claim 2, wherein determining, from the plurality of highlight requests, that the first user of the plurality of users is physically proximate to the second user of the plurality of users comprises determining from the first highlight request and the second highlight request that the first computing device is proximate to the second computing device, wherein the first highlight request comprises a first user identifier indicating the first user, and wherein the second highlight request comprises a second user identifier indicating the second user.

5. The method of claim 2, wherein the first highlight request further comprises an indication that the first computing device is proximate to a beacon, and wherein the second highlight request further comprises an indication that the second computing device is proximate to the beacon.

6. The method of claim 1, wherein at least one of the plurality of highlight requests received from the plurality of users is received as a beacon highlight request via a beacon, the beacon highlight request indicating proximity to a first computing device and a second computing device.

7. The method of claim 6, wherein determining, from the plurality of highlight requests, that the first user of the plurality of users is physically proximate to the second user of the plurality of users comprises:
determining from the beacon highlight request that the first computing device is proximate to the second computing device; and
identifying, from a structured data resource having associations between computing device identifiers and user identifiers, corresponding user identifiers of the first computing device and the second computing device, the corresponding user identifiers indicating the first user and the second user.

8. The method of claim 1, further comprising:
determining, from the plurality of highlight requests, that a third user of the plurality of users is physically proximate to the first user and the second user; and
accessing information associated with the third user;
wherein determining a relationship between the first user and the second user based on the information associated with the first user and the information associated with the second user comprises determining a common relationship between the first user, the second user, and the third user based on information associated with the first user, information associated with the second user, and information associated with the third user; and
wherein obtaining a highlight based on the determined relationship between the first user and the second user comprises obtaining a highlight based on the determined common relationship between the first user, the second user, and the third user.

9. The method of claim 1, further comprising sending the highlight based on the determined relationship between the first user and the second user to a first computing device associated with the first user and to a second computing device associated with the second user.

10. The method of claim 1, wherein accessing information associated with the first user and accessing information associated with the second user comprises accessing a social media feed, social graph, enterprise feed, or enterprise graph.

11. The method of claim 1, wherein obtaining a highlight based on the determined relationship between the first user and the second user comprises obtaining a plurality of highlights corresponding to commonalities between the first user and the second user.

12. The method of claim 11, wherein obtaining the highlight based on the determined relationship between the first user and the second user further comprises ranking the obtained plurality of highlights based on contextual relevance.

13. The method of claim 1, wherein obtaining a highlight based on the determined relationship between the first user and the second user comprises performing statistical analysis on the accessed information associated with the first user and the accessed information associated with the second user information.

14. A computer readable storage medium having instructions stored thereon that when executed by a hardware processor, direct the hardware processor to at least:
receive a plurality of highlight requests from a plurality of users;
determine, from the plurality of highlight requests, that a first user of the plurality of users is physically proximate to a second user of the plurality of users;
access information associated with the first user and access information associated with the second user;
determine a relationship between the first user and the second user based on the information associated with the first user and the information associated with the second user; and
perform a statistical analysis on commonalities between the first user and the second user to obtain a highlight based on the determined relationship between the first user and the second user, wherein the highlight corresponds to a statistically uncommon or uncommonly different commonality between the first user and the second user.

15. The computer readable storage medium of claim 14, wherein the instructions to receive the plurality of highlight requests from the plurality of users directs the hardware processor to at least:
receive a first highlight request from a first computing device associated with the first user, the first highlight request indicating proximity to a second computing device; and
receive a second highlight request from the second computing device associated with the second user, the second highlight request indicating proximity to the first computing device.

16. The computer readable storage medium of claim 14, wherein at least one of the plurality of highlight requests received from the plurality of users is received as a beacon highlight request via a beacon, the beacon highlight request indicating proximity to a first computing device and a second computing device.

17. The computer readable storage medium of claim 16, wherein the instructions that determine, from the plurality of highlight requests, that the first user of the plurality of users is physically proximate to the second user of the plurality of users further directs the hardware processor to at least:
determine from the beacon highlight request that the first computing device is proximate to the second computing device; and
identify, from a structured data resource having associations between computing device identifiers and user identifiers, corresponding user identifiers of the first computing device and the second computing device, the corresponding user identifiers indicating the first user and the second user.

18. The computer readable storage medium of claim 14, further comprising instructions to:
determine, from the plurality of highlight requests, that a third user of the plurality of users is physically proximate to the first user and the second user; and
access information associated with the third user;
wherein the instructions to determine the relationship between the first user and the second user based on the information associated with the first user and the information associated with the second user direct the hardware processor to determine a common relationship between the first user, the second user, and the third user based on the information associated with the first user, the information associated with the second user, and the information associated with the third user; and
wherein the instructions to obtain the highlight based on the determined relationship between the first user and the second user directs the hardware processor to obtain the highlight based on the determined common relationship between the first user, the second user, and the third user.

19. A system comprising:
one or more computer readable storage media;
one or more processors; and
program instructions stored on the one or more computer readable media that, when executed by the one or more processors, direct the system to at least:
receive a plurality of highlight requests from a plurality of users;
determine, from the plurality of highlight requests, that a first user of the plurality of users is physically proximate to a second user of the plurality of users;
access information associated with the first user and accessing information associated with the second user;
determine a relationship between the first user and the second user based on the information associated with the first user and the information associated with the second user; and
obtain a highlight based on the determined relationship between the first user and the second user, wherein the highlight corresponds to a statistically uncommon or uncommonly different commonality between the first user and the second user.

20. The system of claim 19, further comprising instructions to:
determine, from the plurality of highlight requests, that a third user of the plurality of users is physically proximate to the first user and the second user; and
access information associated with the third user;
wherein the instructions to determine the relationship between the first user and the second user based on the information associated with the first user and the information associated with the second user direct the system to determine a common relationship between the first user, the second user, and the third user based on the information associated with the first user, the information associated with the second user, and information associated with the third user; and
wherein the instructions to obtain the highlight based on the determined relationship between the first user and the second user direct the system to obtain the highlight based on the determined common relationship between the first user, the second user, and the third user.
